(19) United States
(12) Patent Application Publication
(10) Pub. No.: US 2018/0165712 A1
(43) Pub. Date: Jun. 14, 2018

(54) METHOD AND APPARATUS FOR COMPOSING SEARCH PHRASES, DISTRIBUTING ADS AND SEARCHING PRODUCT INFORMATION

(71) Applicant: Alibaba Group Holding Limited, Grand Cayman (KY)

(72) Inventor: Yao Sun, Hangzhou (CN)

(73) Assignee: Alibaba Group Holding Limited

(21) Appl. No.: 15/891,179

(22) Filed: Feb. 7, 2018

Related U.S. Application Data
(62) Division of application No. 14/150,082, filed on Jan. 8, 2014.

(30) Foreign Application Priority Data
Jan. 9, 2013 (CN) 201310008041.0

(51) Int. Cl. G06Q 30/02

(52) U.S. Cl. CPC G06Q 30/0256; G06Q 30/0625

(57) ABSTRACT

The present disclosure provides a method and an apparatus for composing search phrases, distributing searchable advertisements and searching for product information using a computer. The computer acquires a search behavioral data, and composes a search phrase based on an original search phrase, a product category selection and a product attribute found in the search behavioral data. The composed search phrase is comprehensive and includes not only the original search phrase, but also information related to the product category selection and the product attribute. The computer distributes advertisements associated with a bid phrase composed in the same manner, and allows searching for distributed advertisements by matching a composed search phrase and a composed bid phrase. The technique enables a product information search, especially a structured search, to be better performed, and its results better indexed and tracked with more precise and relevant statistics.

### RELATED PATENT APPLICATIONS

This application is a divisional of and claims priority to U.S. patent application Ser. No. 14/150,082, filed on Jan. 8, 2014, which claims foreign priority to Chinese Patent Application No. 201310008041.0 filed on Jan. 9, 2013, entitled “METHOD AND APPARATUS FOR COMPOSING KEYWORDS, DISTRIBUTING ADS AND SEARCHING PRODUCT INFORMATION”, Chinese Patent Application is hereby incorporated by reference in its entirety.

### TECHNICAL FIELD

The present application relates to Internet technologies, and more particularly to composing search phrases, distributing ads and searching product information on the Internet.

### BACKGROUND

One of the most effective techniques for distributing product information on the Internet is search keyword-related advertisements driven by a search engine. Search engine advertisement usually involves paid listing of advertisements ranked based on price bidding on search keywords. If an advertiser (a company or an individual who sponsors an advertisement) wishes to have an advertisement content listed in a top position of a search engine return, it bids a relatively high price for a related search keyword. The higher the bidding price is, the higher the ranking of the advertisement is in the listing of the search engine return.

An example of paid search listing of advertisements is as follows. Each advertiser bids a certain price for a keyword, which is a basic bidding unit. The advertiser may associate one or more advertisements (each advertisement being a product information piece) with the keyword. Each keyword may be associated with different advertisements by different advertisers who bid different prices for the keyword. As a search user searches for information using a search engine by entering the search phrase that matches or contains the keyword paid by the advertisers, the search engine finds advertisements that match the keyword, ranks the advertisements according to the bid price paid by the advertisers for the associated keyword, and allows the relevant advertisements to be displayed to the search user in the order of the ranking by the search engine.

In the above-described example, the basic unit for bidding is a keyword. When used with a search engine, this method has several shortcomings.

First, from a search engine point of view, the method suffers low search efficiency. Suppose a search user enters a keyword “Apple” under the mobile phone category to perform a search, all advertisements that contain the keyword “apple” would participate in bidding for the paid listing, including those provided by advertisers who sell apples as a fruit. Consequently, before all the listings are displayed, the search engine needs to perform a relevance analysis in order to filter out product information that is unrelated to mobile phones so only those advertisements under the mobile phone category may be listed. This process increases the amount of computer processing by the server, and reduces search efficiency.

Second, from an advertiser's point of view, even with the search engine's filtration processing, an advertisement is often displayed to a non-intending search user and receives ineffective clicks, resulting in unnecessary charges.

This may be illustrated in the context of structured queries. A structured query typically involves multiple hierarchies, for example categories, attributes and search keywords in a three-tier hierarchical structured search. The first tier, the category, may be “woman's clothing” for example; the second tier, the attribute, may be a color, a material, or a brand, for example; and the third tier, the keyword, may be “trending style of 2011”. A complete structured query is made of contents of all three tiers.

In these search techniques, a bidding unit is usually a search keyword, which is only the third tier keyword component of a structured query, and does not represent the entire structured search query. For an advertiser, the bidding units are the underlying objects of the bidding. The advertiser makes a bidding based on search traffic. However, the search traffic in the prior art techniques is a result of combining the search requests in multiple contexts, some of which may be unrelated to the user's intent to find the product information that is being promoted by the advertiser.

Especially, an advertiser is unable to precisely bid for a certain result of the desired traffic. Although the server receives and processes structured queries, the advertisers can make a bidding with regard to only the keyword component of the structured queries. The quality of the promotion that is visible to the advertiser is also tied to the keyword component alone.

For example, consider these examples of structured queries: “skirt (search keyword)+white (attribute)”, “skirt (search keyword)+short sleeved (attribute)”, and “skirt (search keyword)+children's clothing (category)”. In the current paid listing advertisement based on search engine keyword bidding, advertisers may only bid for the search keyword “skirt”, but all the above three examples of structured queries are merged to the same search keyword “skirt”. Advertisers may only make adjustments on their bidding prices with regard to the search keyword “skirt”, but with no clue to know which structured queries may have better promotional effects.

For another example, if an advertiser for Apple mobile phones has submitted a bid for the search keyword “Apple”, the advertiser has no choice but to join the paid listing bidding for all structured queries that have “Apple” as a search keyword, such as the following three scenarios: “Apple (search keyword)”, “Apple (search keyword)+mobile phone (category)”, and “Apple (search keyword)+carrier-sponsored prepaid phone card (attribute)”.

However, the advertiser may be promoting Apple phones that are not associated with a carrier. For example, Apple phones that are channeled through Hong Kong and sold in mainland China may not be sold with a carrier-sponsored prepaid phone card, and thus lack this attribute. But according to the current CPC (Cost per Click) search engine advertising model, as long as a search user has clicked on an advertisement that results from a search containing the search keyword “Apple”, a fee deduction will be made against the account of the advertiser for that advertisement. That is, for the advertiser selling Apple phones channeled through Hong Kong to China in this example, all clicks on the above third scenario would result in ineffective clicks, yet will cost advertisement fees to the advertiser. In some cases, this leads to not only economic losses for the advertiser, but may also result in poor user experiences and network resource waste because wrong search results may be provided to the search user.

Third, from the search user point of view, imprecise search results also lead to poor user experience. For example, search users who desire to purchase an Apple mobile phone may use any of the following structured queries: “Apple mobile phone (search keyword)”, “mobile phone (category)+Apple (search keyword)”, and “mobile phone (category)+Apple (attribute)”. Because the search engine indexes advertisements only according to the search keywords, the above three structured queries may return different search results because they do not have the same search keyword. On the other hand, the search users who used any of the above structured queries all share the same intention, which is to find an Apple mobile phone. Therefore, the same search intention may lead to different search product information in a search result. This may not be a desirable user experience.

In summary, the present advertisement distribution and product information search are all based on user-entered search keywords, causing problems to the search engine, the advertisers and the search users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure provides a method and an apparatus for composing search phrases, distributing searchable advertisements and searching for product information using a computer, especially in a structured search environment. The computer acquires a search behavioral data collected during a search by a user, and composes a search phrase based on an original search phrase, a product category selection and a product attribute found in the search behavioral data. The composed search phrase is comprehensive and includes not only the original search phrase, but also information related to the product category selection and the product attribute. The computer performs in automatic search using the computer-composed search phrase. The computer may also distribute advertisements associated with a bid phrase composed in the same manner as the search phrase is composed, and allows searching for the distributed advertisements by matching a composed search phrase and a composed bid phrase.

One aspect of the disclosure is a method of composing a search phrase. The method uses a computer to acquire a search behavioral data including an original search phrase entered in a search process, a product category selection selected in the search process and a product attribute being searched. The computer extracts the original search phrase, the product category selection and the product attribute from the acquired search behavioral data, and automatically composes a recommended search phrase by merging the original search phrase, the product category selection, and the product attribute. The recommended search phrase thus composed is comprehensive of elements of the original search phrase, the product category selection, and the product attribute.

To merge the search behavioral data, the computer tokenizes the original search phrase, the product category selection and the product attribute to obtain a plurality of tokenized words, and may further normalize spellings of the plurality of tokenized words. In some embodiments, the computer removes redundant information from the search behavioral data by removing duplicate words or synonyms, and/or merging synonyms or near-synonyms. To do this, a similarity between two tokenized words may be calculated to determine if the two tokenized words are duplicating words, synonyms or near-synonyms by comparing the similarity with a preset threshold value. The computer keeps any one of the two tokenized words and discards the other if the two tokenized words are duplicating words or synonyms, or keeps one of the two tokenized words and discards the other according to a preset condition if the two tokenized words are near-synonyms.

In some embodiments, the computer finds a key content of the search behavioral data in order to have a better defined search phrase. For example, for each tokenized word, the computer acquires an analysis parameter which includes a weight factor of the tokenized word and/or a click rate of the tokenized word. The value of the weight factor depends on whether the tokenized word is from a search phrase, a category selection or a product attribute. The computer then determines a level of significance of each tokenized word according to the respective analysis parameter, and further determines the key content according to the levels of significance of the tokenized words. The computer may reorder the tokenized words according to the levels of significance of the tokenized words in order to optimize the key content.

According to another aspect of the disclosure, a method of distributing advertisements uses a computer to acquire a search behavioral data including an original search phrase entered in a search process, a product category selection selected in the search process, and a product attribute being searched. The computer extracts the original search phrase, the product category selection, and the product attribute from the acquired search behavioral data, and automatically composes a bid phrase by merging the original search phrase, the product category selection, and the product attribute. The computer then receives from advertisers a plurality of bidding prices for the bid phrase and a plurality of advertisements associated with the bid phrase. Each advertisement is associated with one of the plurality of bidding prices. The plurality of advertisements are indexed according to the associated bid phrase, and ranked according to the respective bidding prices. The computer then populates the indexed and ranked plurality of advertisements to an advertisement database to be available for search.

Upon receiving a search phrase, the computer matches the search phrase with the bid phrase; and allows at least some of the plurality of advertisements selected according to the respective bidding prices to be displayed. In some embodiments, the search phrase is at least partially machine-composed using the method for composing search phrases disclosed herein.

The computer may log statistics of advertisement effectiveness data of the advertisements associated with the bid phrase, and provide the statistics indexed according to the bid phrase to the advertisers. The advertisement effectiveness data may include at least one of the following data: data of users browsing the advertisements on webpages, data of users clicking the advertisements, and data of users completing transactions of products or services advertised by the advertisements.

Yet another aspect of the disclosure is a method for searching product information. A computer automatically composes a recommended search phrase by merging the search behavioral data, using the method of composing a search phrase as disclosed herein. The computer then matches the recommended search phrase with a bid phrase stored in the product information database, and allows at least some of the plurality of advertisements associated with the bid phrase which matches the recommended search phrase. To match recommended search phrase with the bid phrase, the computer may first match the recommended search phrase with the bid phrase according to a precise matching rule, and if the matching according to the precise matching rule fails, then match the recommended search phrase with the bid phrase according to a fuzzy matching rule. The fuzzy matching rule may require a match between the original search phrase and a part of the bid phrase. If the matching according to the precise matching rule fails, the computer may also add the recommended search phrase as a new bid phrase to the product information database.

In some embodiments, the bid phrase itself is at least partially machine-composed by merging information of a prior search behavioral data.

To implement the method of composing a search phrase, a computer is programmed to have a data acquisition module, a data extraction module, and a search phrase composition module to perform functions required by the method disclosed herein. For example, the data acquisition module is configured for acquiring a search behavioral data including an original search phrase entered in a search process, a product category selection selected in the search process, and a product attribute being searched. The data extraction module is configured for extracting the original search phrase, the product category selection, and the product attribute from the acquired search behavioral data. The search phrase composition module is configured for automatically composing a recommended search phrase by merging the search behavioral data.

To implement the method for distributing advertisements, a computer is programmed to have a data acquisition module, a data extraction module, a phrase composition module, an advertisement information receiving module, a ranking module, and a product information distribution module. The modules are programmed to perform functions of the method for distributing advertisements as disclosed herein.

To implement a method for searching product information, a computer is programmed to have a data acquisition module, a data extraction module, a search phrase composition module, and a matching module. The modules are programmed to perform functions of the method for searching product information as disclosed herein. For example, the matching module is configured for matching the recommended search phrase with a bid phrase stored in the product information database, and for allowing at least some of the plurality of advertisements associated with the bid phrase which matches the recommended search phrase to be displayed.

The disclosed techniques enable structured search to be better indexed, and better tracked with more precise and more relevant statistics.

Other features of the present disclosure and advantages will be set forth in the following description, and in part will become apparent from the description, or understood by practice of the application. Purposes of this application and other advantages can be obtained by the written description, claims, and drawings of the structure particularly pointed out realized and attained.

### BRIEF DESCRIPTION OF THE FIGURES

FIG. 1 is a flowchart of a method for composing a search phrase in accordance with the present disclosure.

FIG. 2 is a flowchart of a method for distributing advertisements in accordance with the present disclosure.

FIG. 3 is a flowchart of a method for searching product information in accordance with the present disclosure.

FIG. 4 is a block diagram representing a computer-based apparatus configured for composing the search phrase in accordance with the present disclosure.

FIG. 5 is a block diagram representing a computer-based apparatus configured for distributing advertisements in accordance with the present disclosure.

FIG. 6 is a block diagram representing a computer-based apparatus configured for searching product information in accordance with the present disclosure.

### DETAILED DESCRIPTION

In order to facilitate understanding of the above purpose, characteristic and advantages of the present disclosure, the present disclosure is described in further detail in conjunction with accompanying figures and example embodiments. In the description, the term “technique(s),” for instance, may refer to method, apparatus device, system, and/or computer-readable instructions as permitted by the context above and throughout the present disclosure.

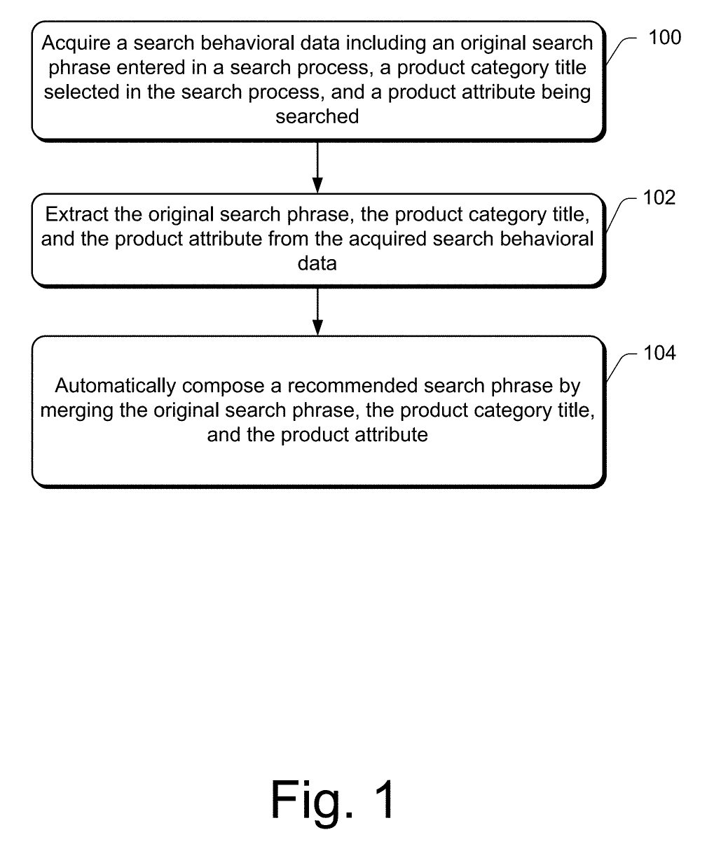

FIG. 1 is a flowchart of a method for composing a search phrase in accordance with the present disclosure. The method is described in blocks as follows.

At block 100, a computer acquires a search behavioral data including an original search phrase entered in a search process, a product category selection selected in the search process, and a product attribute being searched.

The search behavioral data may be obtained from query logs. The original search phrase is one or more query words entered by a search user who is conducting a search. An example of a search phrase is “slim tops”. The product category selection may be a menu item in a multi-tiered category. For example, a first tier category may be entitled “woman's clothing”, a second tier category may be entitled “T-shirts”, and third tier category may be entitled “long sleeved T-shirts”. A search user may have selected the three-tier category when conducting a search for product information. The product attribute may include both the attribute name and the attribute value. The attribute name indicates or describes a property of a product or a type of products. For example, under the category “long sleeved T-shirts”, an example of an attitude name is “color”, indicating the color of the products in that category, while the attribute value may be “white”, “read”, “blue”, or “yellow” etc. A product or a category of products may have multiple attributes each having multiple values. For example, in addition to “color”, other examples of attribute names may be “material” and “size”, etc. Different product categories may share a common attribute with the same attribute name, but the same attribute name may have different attribute values in each category and further across different categories.

At block 102, the computer extracts the original search phrase, the product category selection, and the product attribute from the acquired search behavioral data.

For example, from the above example of search behavioral data acquired at block 100, information such as the original search phrase “slim tops”, the product category selection “woman's clothing>T-shirts>long sleeved T-shirts”, and the product attribute “white” for the product color, may be extracted at this block.

At block 104, the computer automatically composes a recommended search phrase by merging the original search phrase, the product category selection, and the product attribute. The recommended search phrase composed this way is comprehensive of at least some elements of the original search phrase, the product category selection, and the product attribute.

The elements to be included in the recommended search phrase are obtained after the computer has processed the search behavioral data. The computer may perform various acts in order to process the search behavioral data. Examples of processing acts include tokenization, removal of duplicating words and synonyms, merging near-synonyms, key content analysis, and reordering of the words, which are described separately as follows.

(1) Tokenization

To process the search behavioral data, the computer tokenizes the original search phrase, the product category selection and the product attribute to obtain tokenized words.

Tokenization is a process to form a sequence of words and phrases by separating and recombining a sequence of characters or alphabets (or other units smaller than words and phrases) according to a set of language rules. The process is also more broadly referred to as word segmentation in other contexts. In this application, no distinction is made between tokenization and word segmentation.

A variety of tokenization algorithms exist, such as character string (or alphabetic string) algorithms, semantic algorithms, and statistical algorithms. Any viable tokenization algorithm may be used for the purpose of the present disclosure, and the description herein does not limit such choice of algorithms.

For example, “slim tops” may be tokenized into two elements or units: “slim” and “tops”.

(2) Redundancy Removal and Synonym Merge

In some embodiments, the computer removes redundant information from search behavioral data. For example, the computer may remove duplicate words or synonyms, and/or merge synonyms or near-synonyms. To do this, the computer calculates a similarity between the two tokenized words of any pair among the tokenized words. There are variety of ways to calculate (or estimate) the similarity between two words. For example, the similarity between two tokenized words may be estimated based on a textual similarity of the two tokenized word. The similarity between two tokenized words in different languages may be estimated based on a textual similarity after the translation. The translation from one language to another may either be done automatically by the computer using a translation tool, or based on a word correspondence preset manually. For example, the Chinese word “ping'guo” may be considered to have a high similarity with the English word “Apple” based on the translation. The similarity may also be estimated according to a correlation between the search word entered by the user and the corresponding click made by the same user. For example, if the user entered a search phrase “big girl” and selected the product category “plus size”, the computer may estimate that “big girl” and “plus size” have relatively high similarity.

The computer may then determine if the two tokenized words are duplicating words, synonyms or near-synonyms by comparing the calculated similarity with a preset threshold value. For example, a threshold of a 95% similarity may be set for synonyms, and any two tokenized words that have a similarity at or above the 95% threshold may be considered synonyms. A threshold of 85% similarity may be set for near-synonyms, and any two tokenized words that have a similarity at or above the 85% threshold but below 95% may be considered near-synonyms.

If the two tokenized words are duplicating words or synonyms, the computer keeps any one of the two tokenized words and discarding the other. For words that are identical, almost identical, or synonyms with a high similarity, only one of them needs to be kept, and the selection can be made arbitrarily or according to any arbitrarily preset rule. There is no limitation in this regard.

If the two tokenized words are near-synonyms, the computer may keep one of the two tokenized words and discarding the other according to a preset condition. The selection of the work to be kept is preferably not arbitrary but based on a desirable condition. For example, with regard to the synonyms “big girl” and “plus size”, because “big girl” is a user entered phrase, while “plus size” is an attribute under a product category, it may be preferable to keep “plus size” and discard “big girl” because an attribute in the system may have a higher degree of generality for common use than an individual user's entry.

(3) Key Content Analysis

In some embodiments, the computer finds a key content of the original search phrase, the product category selection and the product attribute in order to have a better defined search phrase.

For example, after redundancy removal and near-synonym merge, the computer may acquire, for each tokenized word, an analysis parameter which includes a weight factor of the tokenized word and/or a click rate of the tokenized word. The value of the weight factor may depend on whether the tokenized word is from a search phrase, category information or a product attribute.

The value of the weight factor of each tokenized word affects the level of significance of the tokenized word. Search phrases, multitiered product categories, and product attributes, each as a class may carry different weight. In the e-commerce environment, for example, the product category determines the product's type or classification and is therefore the most important, and may be represented by, for example, a three-star rating. The product attribute is usually standardized and is capable of describing an important characteristic of the product, and is therefore also important, although may not be as important as the product category, and may be represented by for example, a two-star rating. The search phrase, although very important in the search engine environment, is less important in the e-commerce environment than the product category, and perhaps has an importance comparable to that of the attribute, and is therefore represented, for example, also by a two-star rating.

In addition, the click rate of each tokenized word also affects the significance of the tokenized word to a certain degree. Usually, a word that is more frequently clicked by users is more significant than the word that is less frequently clicked. There may be other factors that affect the significance of a tokenized word, in addition to the examples described herein.

Next, for each tokenized word, the computer then determines a level of significance according to the respective analysis parameter (a weight factor and/or a click rate), and determines the key content according to the levels of significance of the tokenized words.

Generally, tokenized words that have the highest significance should be first considered to be included in the key content. For example, out of the extracted information of “white, skirt, woman's clothing, one-size-fits-all”, if it is determined that the word “skirt” has the highest significance, then the key message of the extracted information is “skirt”, while “white”, “woman's clothing”, and “one-size-fits-all” are just qualifiers added to the key.

(4) Reordering

For each tokenized word, upon determining a level of significance according to the respective analysis parameter, the computer may reorder the tokenized words according to the levels of significance of the tokenized words.

For example, given the general pattern of word order in Chinese language, words that have a higher level of significance may be placed behind the words that have a lower level of significance. As described herein, a tokenized word that indicates the product category has a high level of significance, and therefore should be placed behind other words. In contrast, words that are just qualifiers that have lesser importance are placed behind the more important words.

The above described tokenized word processing is further illustrated below using an example.

Using the example described in the above block 102, where the original search phrase is “slim tops”, the multitiered product category is “woman's clothing>T-shirts>long-sleeved T-shirts”, and the product attribute is “white”, and all extracted information is merged using tokenization, synonym removal, near-synonym merge, key content analysis and reordering, as further described below.

1. Tokenization: the original search phrase “slim tops”, the multitiered product category “woman's clothing>T-shirts>long sleeved T-shirts”, and the product attribute “white” are tokenized to a tokenized word collection represented by {(slim, tops)+(woman's clothing, T-shirts, long sleeved, T-shirts)+(white)}.

2. Synonym removal: Assuming the threshold similarity for a synonym is 95%, upon calculating the similarity of all pairs of tokenized words among the above tokenized word collection, it is discovered that the tokenized word “T-shirts” appeared twice in the collection because the first “T-shirts” and the second “T-shirts” have a similarity of 100%, which is greater than the threshold similarity 95%, and therefore are treated as duplicating words or synonyms. To proceed, the first T-shirt is removed, and the second “T-shirt” which comes from “long-sleeved T-shirt” is kept. As a result, the updated collection of tokenized words after synonym removal is {(slim, tops)+(woman's clothing, long sleeved, T-shirts)+(white)}.

3. Near-synonym merge: Assuming the threshold similarity for a near-synonym is 80%, among the above updated tokenized words, the similarity between “tops” and “T-shirts” is 85%, greater than the near-synonym threshold 80% but smaller than the synonym threshold 95%. These two tokenized words are therefore seen as near-synonyms, of which the tokenized word “tops” is removed while the tokenized word “T-shirts” is kept. As a result, the updated tokenized word collection after near-synonym merge is {(slim)+(woman's clothing, long-sleeved, T-shirts)+(white)}.

4. Key content analysis: The above updated tokenized words have the following analysis parameters:

“slim” corresponds to the following analysis parameters: search word with a two-star weight factor, and click rate 50%;

“woman's clothing” corresponds to the following analysis parameters: first tier category with a three-star weight factor, and click rate 60%;

“long sleeved” corresponds to the following analysis parameters: second-tier category with a three-star weight factor, and click rate 20%;

“T-shirt” corresponds to the following analysis parameters: third-tier category with a three-star weight factor, and click rate 35%; and

“white” corresponds to the following analysis parameters: attribute with a two-star weight factor, click rate 40%.

In the present example, the level of significance of a tokenized word indicating a product category is higher than that of either a tokenized word indicating a product attribute or a tokenized word which is a search word, while the level of significance of a tokenized word indicating a product attribute is comparable to that of a tokenized word which is a search word.

Of the remaining tokenized words, “Woman's clothing”, “long sleeved”, and “T-shirts” are all product categories, but the click rate of “long sleeved” is significantly lower than that of “woman's clothing” and “T-shirts”. As a result, the level of significance of the tokenized word “long sleeved” may be adjusted to be below that of “woman's clothing” and “T-shirts”.

Based on the above-discussed analysis parameters, the adjusted level of significance of each tokenized word is listed as follows:

“slim”: two-star;

“woman's clothing”: three-star;

“long sleeved”: two-star;

“T-shirts”: two-star;

“white”: two-star.

Based on the above analysis, it is determined that the key content is “woman's clothing T-shirts”

5. Reordering: after placing the tokenized word(s) in order according to their levels of significance, the resultant order of the tokenized words is as follows:

“slim” “long sleeved” “white” “woman's clothing” “T-shirt”.

Taking into consideration the original search intent and conventional rules, the tokenized word may be further adjusted to a search phrase “white slim long sleeved woman's T-shirt”.

As shown above, the final search phrase is composed by the computer based on a comprehensive integration of all three parts, namely the original search phrase part, the product category, and the product attribute under the category, and more accurately reflects the user's original search intent in the search context.

After tokenization and before synonym removal and near-synonym merge, the computer may further normalize spellings of the plurality of tokenized words. For example, tokenized words in different languages (e.g., Chinese and English) may be normalized into a standard or common language. Capitalized letters and lowercase letters may also be normalized. Nominalization benefits the calculation of textual similarity and thus helps the process of synonym removal and near-synonym merge.

Based on the processes described above, in the illustrated example, if the search behavioral data is {white skirt (original search phrase)}, the resultant computer-composed recommended search phrase will be “white skirt”; if the search behavioral data is {skirt (original search phrase)+white (attribute)}, the resultant computer-composed recommended search phrase will still be “white skirt”. As a result, the traffic for the searches based on {white skirt (original search phrase)} and the searches based on {skirt (original search phrase)+white (attribute)} are merged together.

In summary, the method according to the above embodiment composes a recommended search phrase by comprehensively integrating the original search phrase entered in the search process, the product category selected by the user and the product attribute selected by the user. The resultant recommended search phrase better reflects the actual search intent, achieves a purpose of integrating information contained in a structured search context (e.g., the search phrase, the product category and the product attribute), and enables “de-structuralizing” the structured searches.

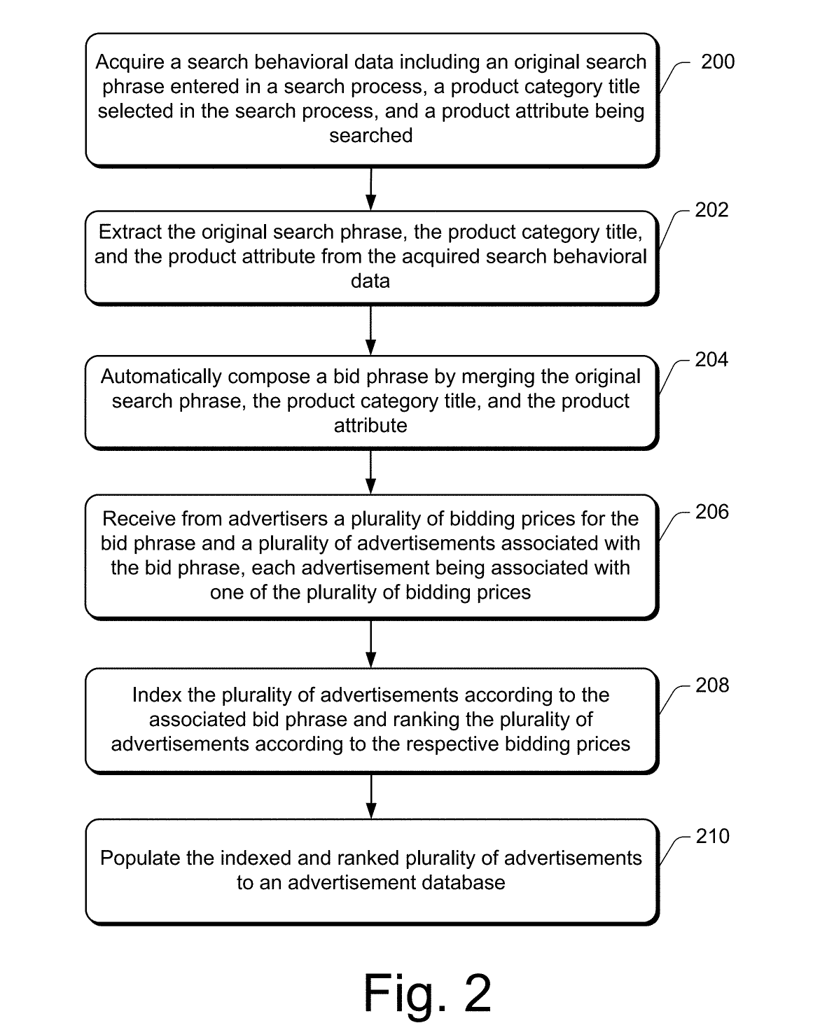

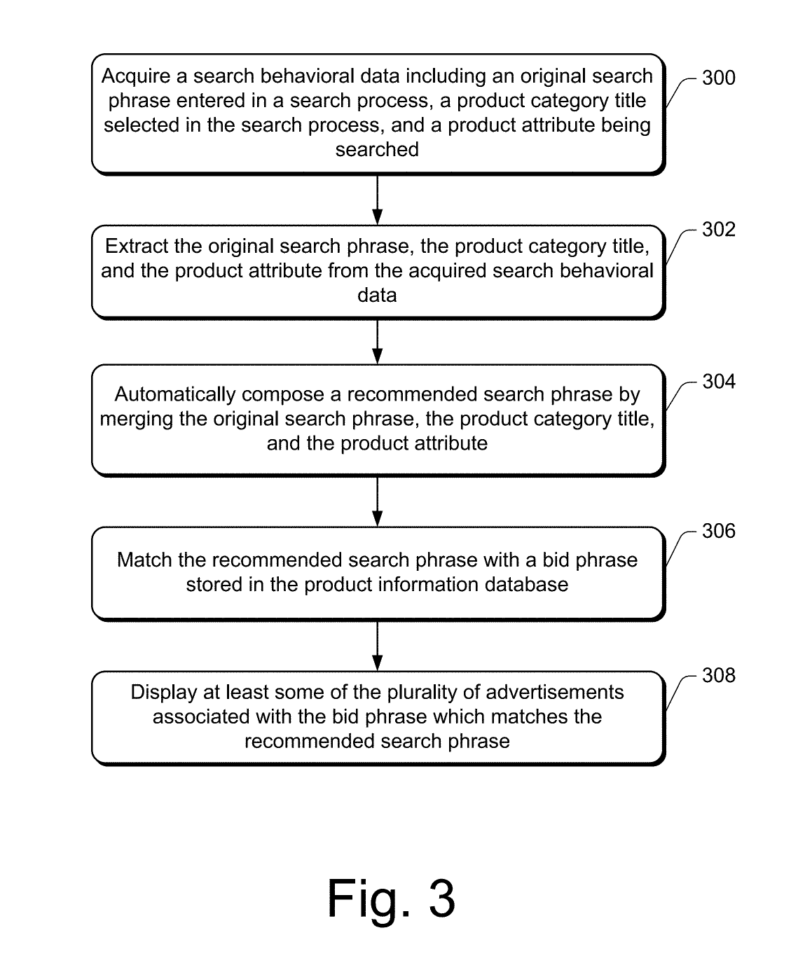

The recommended search phrase composed this way may also be used as a bid phrase in the method for distributing advertisements, as illustrated in FIG. 2, to improve the bidding accuracy by the advertisers. The recommended search phrase may also be used as a search phrase in the method for searching product information, as illustrated in FIG. 3, to improve the search engine accuracy and search result relevancy.

FIG. 2 is a flowchart of a method for distributing advertisements in accordance with the present disclosure. The method is described in blocks as follows.

At block 200, a computer acquires a search behavioral data including an original search phrase entered in a search process, a product category selection selected in the search process, and a product attribute being searched. The search behavioral data may be acquired from query logs.

At block 202, the computer extracts the original search phrase, the product category selection, and the product attribute from the acquired search behavioral data.

At block 204, the computer automatically composes a bid phrase by merging the original search phrase, the product category selection, and the product attribute. The merging process may involve tokenization of the extracted information, and may further include synonym removal, near-synonym merge, key content analysis and reordering of the tokenized words, as described herein in the embodiment illustrated in FIG. 1.

At block 206, the computer receives from advertisers a plurality of bidding prices for the bid phrase and a plurality of advertisements associated with the bid phrase. Each advertisement may be associated with one of bidding prices.

Each advertiser may choose one or more bid phrases, choose or offer a respective bidding price for each chosen bid phrase, and provide a piece of product information (an advertisement) to be associated with each chosen bid phrase. Multiple advertisers may choose the same bid phrase and associate different advertisements with the bid phrase.

At block 208, the computer indexes the advertisements according to the associated bid phrase and ranks the advertisements according to the respective bidding prices. Usually, an advertisement that has a higher bidding price is ranked higher. It is noted that the ranking may take place later at the time of a search after block 210.

At block 210, the computer populates the indexed and ranked advertisements to an advertisement database. The advertisements populated in the advertisement database is ready to be searched, using a method for search advertisements as described below and in FIG. 3 below, for example.

If a user searches one of the chosen bid phrases (or if a search is performed using a search phrase that matches one of the chosen bid phrases), the associated advertisements will be listed in a search return according to the ranking. The search phrase itself may be at least partially machine-composed, as illustrated in the method of composing a search phrase in FIG. 1. The process of composing such a search phrase may involve acquiring another search behavioral data including its own original search phrase entered in another search process, its own product category selection, and a product attribute being searched in that search process. Like that described in FIG. 1, to compose such a search phrase, the computer extracts the respective original search phrase, the product category selection, and the product attribute from this acquired search behavioral data, and automatically composes the search phrase by merging the information contained therein.

In one embodiment, the method for distributing advertisements logs statistics of advertisement effectiveness data of the advertisements associated with the bid phrase. Like the advertisements themselves, the respective advertisement effectiveness data may be indexed according to the associated bid phrase. The advertisement effectiveness data may include one or more of the following data: data of users browsing the advertisements on webpages, data of users clicking the advertisements, and data of users completing transactions of products or services advertised by the advertisements. The method further provides the statistics indexed according to the bid phrase to the advertisers for analysis.

The advertisement effectiveness data helps advertisers make adjustments to their bidding prices and the contents of the advertisements associated with the bid phrases. For example, if an advertiser finds from the advertisement effectiveness data that the advertisements associated with the bid phrase “white skirts” is effective, the advertiser may desire to increase the bidding price associated with the bid phrase “white skirts” in order to improve the ranking of the advertiser's advertisements in searches.

Indexing the advertisement effectiveness data according to the bid phrases tells a clearer relationship between the advertisement effectiveness and the bid phrases, and helps advertisers evaluate the effectiveness of each bid phrase and make adjustments of the prices and advertisement contents based on specific and relevant statistics. As advertisers adjust their bid prices and advertisements, the changes are populated in the product information database accordingly.

Taking machine-composed recommended search phrases as bid phrases further allows the search traffic to be separated (partitioned) or merged according to the bid phrases, and enables the advertisers to bid for each bid phrase based on the relevant traffic information specifically tailored for that bid phrase with increased bidding accuracy. This is further illustrated below.

First, the method enables search traffic merge. For example, if a user wishes to purchase an Apple phone, the user may use any of the following search scenarios: enter a search phrase “Apple phone” to search; enter a search phrase “Apple” under the category “phones”; or search under the category “phone” with “Apple” as an attribute. Because the prior art techniques use flat bid phrases which are based simply on search phrases entered by the users, the user would receive different product information in the search result in the above three different search scenarios which have different search phrases. Furthermore, in the different scenarios, the advertisers involved may also be different. In this sense, the prior art techniques divide the biddings behind the search traffic too deeply. As a result, the advertisers need to purchase three different bid phrases in order to optimize the advertisement in effect in the above three different search scenarios, even though the search users all have the same intention in doing the search.

In contrast, because the method disclosed herein uses a structured bid phrase which integrates multiple elements of the search (i.e., they original search phrase entered by the user, the product category information and the product attribute information), the above three different search scenarios all lead to the same bid phrase, which is “Apple phone”. As a result, the advertisers need to purchase only one bid phrase “Apple phones” to be able to participate the bid listing of the advertisements in all three different search scenarios. This results in an advantageous merge of the traffic from three different search scenarios.

For another example, purchasing a single bid phrase “white skirt” may allow an advertiser to participate the bid listing of its advertisements in the following search situations:

1. white skirt (search phrase)

2. skirt (search phrase)+white (attribute)

3. white (search phrase)+skirt (category)

4. skirt (category)+white (attribute)

The advertisement displays (views), clicks, click prices, and post-click transactions of the all above four different search scenarios may be recorded and reported under the single bid phrase “white skirt”, thus enabling packaged advertisement price auction to the advertisers for all search traffic that share the same search intentions of the users. Merging the traffic under the same search intentions improves the economics of the advertisers, and also makes it easier to auction the bid phrases with meaningful deep merges of the biddings.

Second, the method also enables traffic partition. For example, with the prior art flat bid phrases, an advertiser may have to purchase a bid phrase “skirt” which is broad enough to catch the following search scenarios where search users enter “skirt (search phrase)+white (attribute)”, “skirt (search phrase)+blue (attribute)”, “skirt (search phrase)+short sleeved (attribute)” or “skirt (search phrase)+children's clothing (category)”, respectively. However, because in the prior art techniques the traffic of all these search scenarios are merged to the bid phrase “skirt”, the advertiser is unable to tell the difference of the advertisement effect in these search scenarios, and has no way to learn scenario-specific information from the actual purchase transactions in each scenario.

In contrast, using the method disclosed herein, the above four search scenarios result in four different recommended search phrases, namely “white skirt”, “blue skirt”, “short sleeved skirt” and “children's skirt”, respectively. As a result, the traffic corresponding to each search scenario is recorded separately to provide precise information for the advertiser to adjust the bidding prices accordingly based on different advertisement effects of different products.

It is noted that the above bid phrase in FIG. 2 may be a recommended search phrase created by the method for composing a recommended phrases as described in FIG. 1, and as a result the method of FIG. 2 may be combined with the method of FIG. 1.

FIG. 3 is a flowchart of a method for searching product information in accordance with the present disclosure. The method is described in blocks as follows.

At block 300, a computer acquires a search behavioral data including an original search phrase entered in a search process, a product category selection selected in the search process, and a product attribute being searched.

At block 302, the computer extracts the original search phrase, the product category selection, and the product attribute from the acquired search behavioral data.

At block 304, the computer automatically composes a recommended search phrase by merging the original search phrase, the product category selection, and the product attribute. The process of composing the recommended search phrase is described with reference to FIG. 1 in the method of composing a search phrase, and is not repeated.

At block 306, the computer matches the recommended search phrase with a bid phrase stored in a product information database.

The product information database stores multiple bid phrases, and multiple advertisements each associated with a bid phrase. The computer searches in the product information database to find a bid phrase that matches the current recommended search phrase.

At block 308, the computer allows at least some of the advertisements associated with the bid phrase which matches the recommended search phrase to be displayed to the search user. Specifically, upon finding a bid phrase that matches the recommended search phrase, the computer provides the advertisements associated with the matching bid phrase to be displayed to the search user. The display is usually based on a ranking according to the bid prices of the advertisements offered by the advertisers.

Because the recommended search phrase is composed by integrating the multiple aspects of a search context (i.e., original search phrase, the product category information and the product attribute information), the recommended search phrase reflects the search intention of the user more accurately, and results in better search accuracy.

To match the recommended search phrase with the bid phrase comprises, the computer may first match the recommended search phrase with the bid phrase according to a precise matching rule. A typical precise matching rule may require an exact or almost exact match. If a precise match is found, the advertisements associated with the found matching bid price are displayed. But if the matching according to the precise matching rule fails, the computer then matches the recommended search phrase with the bid phrase according to a fuzzy matching rule. The fuzzy matching rule is to find a bid phrase which is, although not an exact match, related to the current recommended search phrase. For example, the fuzzy matching rule may require a match between the original search phrase and a part of the bid phrase. If a related bid phrase is found based on the fuzzy matching rule, the computer allows the advertisements associated with the related to phrase to the displayed.

In addition, if the matching according to the precise matching rule fails, the computer may add the recommended search phrase as a new bid phrase to the product information database to allow the product information database to be constantly updated.

The method as illustrated is able to convert the search behavioral data of search users to recommended search phrases which better reflect the real intention of the search users. In the embodiments were the bid phrases of the product information database are also based on the machine-composed search phrases, using the same or similar machine-composed search phrases to search the product information database results in more efficient search engine performance, more accurate search results and better search user experiences.

For example, in the prior art which uses flat search phrases as bid phrases, if a user search for “Apple” under the category “phones”, even advertisements by advertisers who are fruit vendors may participate the bidding. To display relevant product information to the search user, the system often needs to further process the advertisements in order to filter out those advertisements for apples which are unrelated to phones. In other words, the system essentially first searches all product information using the keyword “apple”, and then filters the search results based on the relevant context in order to display product information that is relevant to the current context. This causes a lot of wasteful use of computer and network resources.

In contrast, when the matching-composed search phrases disclosed herein are used as bid phrases, if a user searches for “Apple” under the category “phones”, a bid phrase “Apple phones” is generated by the computer, and the search is performed using the recommended search phrase “Apple phones”, therefore the advertisements by fruit vendors will not match the recommended search phrase and consequently not participate the bidding. The search engine needs not to first find all information and then filter it out, but instead is able to avoid such information altogether in the process. This increases the search engine efficiency and avoids unnecessary operation costs. In addition, the search phrase actually used by the computer in this situation is “Apple phones” which more accurately reflects the user intention and leads to more accurate search results.

It is noted that in this description, the order in which a process is described is not intended to be construed as a limitation, and any number of the described process blocks may be combined in any order to implement the method, or an alternate method. An embodiment is described in sequential steps only for the convenience of illustration. Further, not every step described in the embodiments is required by the method.

The above-described techniques may be implemented with the help of one or more non-transitory computer-readable media containing computer-executable instructions. The non-transitory computer-executable instructions enable a computer processor to perform actions in accordance with the techniques described herein. It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

In connection to the method disclosed herein, the present disclosure also provides a computer-based apparatus for processing online transactions.

In the presence disclosure, a “module” in general refers to a functionality designed to perform a particular task or function. A module can be a piece of hardware, software, a plan or scheme, or a combination thereof, for effectuating a purpose associated with the particular task or function. In addition, delineation of separate modules does not necessarily suggest that physically separate devices are used. Instead, the delineation may be only functional, and the functions of several modules may be performed by a single combined device or component. When used in a computer-based system, regular computer components such as a processor, a storage and memory may be programmed to function as one or more modules to perform the various respective functions.

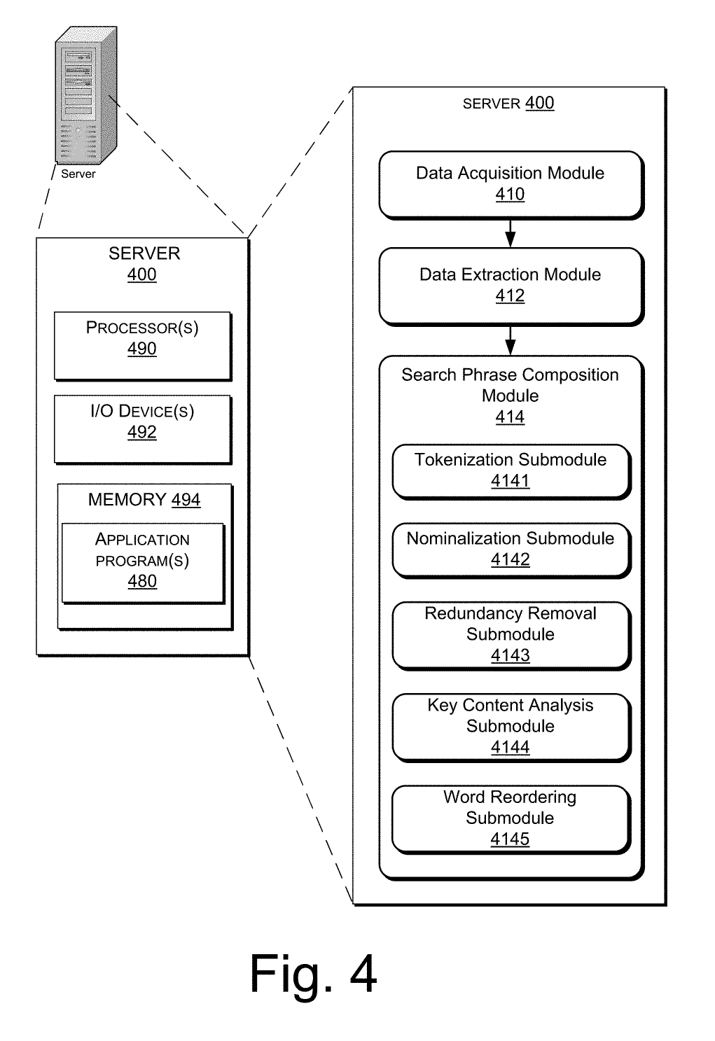

FIG. 4 is a schematic block diagram of a computer-based apparatus configured to implement a method for composing recommended search phrases based on the first example method shown herein with reference to FIG. 1. The computer-based apparatus includes server 400 which has one or more processor(s) 490, I/O devices 492, and memory 494 which stores application program(s) 480. The server 400 is programmed to have the functional modules as described in the following.

Data acquisition module 410 is configured for acquiring a search behavioral data including an original search phrase entered in a search process, a product category selection selected in the search process, and a product attribute being searched. The search behavioral data may be obtained from query logs.

Data extraction module 412 is configured for extracting the original search phrase, the product category selection, and the product attribute from the acquired search behavioral data. For example, the data extraction module 412 may extract an original search phrase “slim tops”, a multitiered product category selection “woman's clothing>T-shirts>long sleeved T-shirts” and a product attribute “white”, from a search behavioral data obtained by data acquisition module 410.

Search phrase composition module 414 is configured for automatically composing a recommended search phrase by merging the search behavioral data. The resultant recommended search phrase is comprehensive of elements of the original search phrase, the product category selection, and the product attribute.

In one embodiment, search phrase composition module 410 may be programmed to include submodules to perform other functions described as follows.

Tokenization submodule 4141 is configured for tokenizing the search behavioral data. Nominalization submodule 4142 is configured for normalizing the tokenized words to eliminate discrepancies such as language differences and upper and lowercase differences. Redundancy removal submodule 4143 is configured for calculating similarities of any pair of two tokenized words among the collection of tokenized words, determining whether each pair of two tokenized words are synonyms or near-synonyms using a respective predefined threshold, and removing one of the synonyms in a pair, or deciding which one of the near-synonyms in the pair is to be removed.

Key content analysis submodule 4144 is configured for finding a key content of the search scenario (which includes original search phrase, the product category selection and the product attribute) in order to have a better defined search phrase. For example, after a redundancy removal and/or a synonym merge, key content analysis submodule 4144 may acquire, for each tokenized word, an analysis parameter which includes a weight factor of the tokenized word and/or a click rate of the tokenized word. The value of the weight factor may depend on whether the tokenized word is from a search phrase, category information or a product attribute. For each tokenized word, key content analysis submodule 4144 then determines a level of significance according to the respective analysis parameter. Key content analysis submodule 4144 then further determines the key content according to the levels of significance of the tokenized words.

Word reordering submodule 4145 is configured for reordering the tokenized words according to the levels of significance of the tokenized words after key content analysis submodule 4144 has determined a level of significance according to the respective analysis parameter for each tokenized word.

The functions performed by the functional modules of server 400 have been described with reference to FIG. 1 in the method of composing recommended search phrases, and are therefore not repeated. The computer-based apparatus according to the above embodiment composes a recommended search phrase by comprehensively integrating the multiple information elements of a search scenario. The resultant recommended search phrase better reflects the actual search intent, achieves a purpose of integrating the search phrase, product category and product attribute, and enables “de-structuralizing” the structured searches.

The recommended search phrase thus created may be used as a bid phrase for advertisers to promote products, as in the method of distributing advertisements described in FIG. 2.

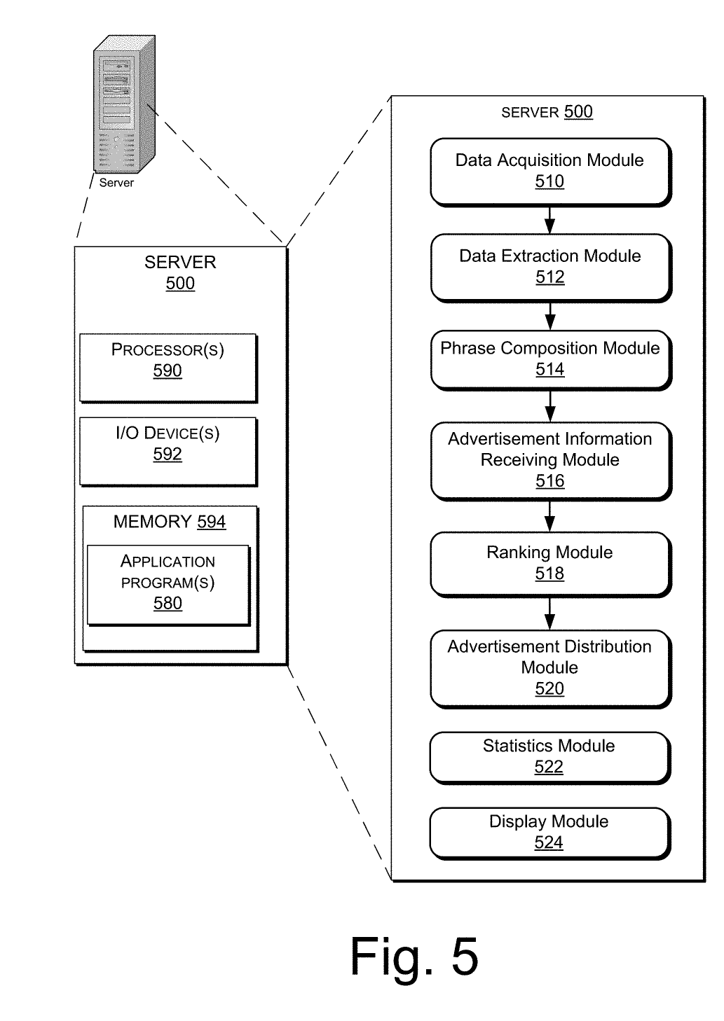

FIG. 5 is a block diagram representing a computer-based apparatus configured for distributing advertisements in accordance with the present disclosure. The computer-based apparatus includes server 500 which has one or more processor(s) 590, I/O devices 592, and memory 594 which stores application program(s) 580. The server 500 is programmed to have the functional modules as described in the following.

Data acquisition module 510 is configured for acquiring a search behavioral data including an original search phrase entered in a search process, a product category selection selected in the search process, and a product attribute being searched.

Data extraction module 512 is configured for extracting the original search phrase, the product category selection, and the product attribute from the acquired search behavioral data.

Phrase composition module 514 is configured for automatically composing a bid phrase by merging the original search phrase, the product category selection, and the product attribute. It is noted that the bid phrase may be a recommended search phrase created by the apparatus for composing a recommended phrases as described in FIG. 4, and as a result phrase composition module 514 of FIG. 5 may be the same as search phrase composition module 414, and not a separate module performing a distinctive function.

Advertisement information receiving module 516 is configured for receiving from advertisers a plurality of bidding prices for the bid phrase, and a plurality of advertisements associated with the bid phrase. Each advertisement is associated with one of the bidding prices.

Ranking module 518 is configured for indexing the advertisements according to the associated bid phrase and ranking the advertisements according to the respective bidding prices.

Advertisement distribution module 520 configured for populating the indexed and ranked advertisements to an advertisement database.

As further shown in FIG. 5, in some embodiments, server 500 may be programmed to further include statistics module 522 and display module 524. Statistics module 522 logs statistics of advertisement effectiveness data of the advertisements associated with the bid phrase, using the bid phrase to index the statistics. The advertisement effectiveness data includes one or more of the following: data of users browsing the advertisements on webpages, data of users clicking the advertisements, and data of users completing transactions of products or services advertised by the advertisements. Statistics module 522 may further provide the statistics indexed according to the bid phrase to the advertisers. Display module 524 allows the provided statistics and effectiveness metrics to be displayed to the advertisers.

Distributing advertisements indexed according to computer-composed bid phrases results in advertisement effectiveness data that tells a clearer relationship between the advertisement effectiveness and the bid phrases, and helps advertisers evaluate the effectiveness of each bid phrase and make adjustments of the prices and advertisement contents based on specific and relevant information. As advertisers adjust their bid prices and advertisements, the changes are populated in the product information database accordingly.

Furthermore, taking machine-composed recommended search phrases as bid phrases allows the search traffic to be separated (partitioned) or merged according to the bid phrases, and enables the advertisers to bid for each bid phrase based on the relevant traffic information specifically tailored for that bid phrase with increased bidding accuracy.

The functions performed by the functional modules of server 500 have been described with reference to FIG. 2 in the method of distributing advertisements, and are therefore not repeated.

As illustrated further below, a method for searching product information may be formed based on a combination of recommended search phrases composed using the method and the apparatus described in FIGS. 1 and 4, and the distributed advertisements indexed with the bid phrases and distributed using the method and the apparatus described in FIGS. 2 and 5.

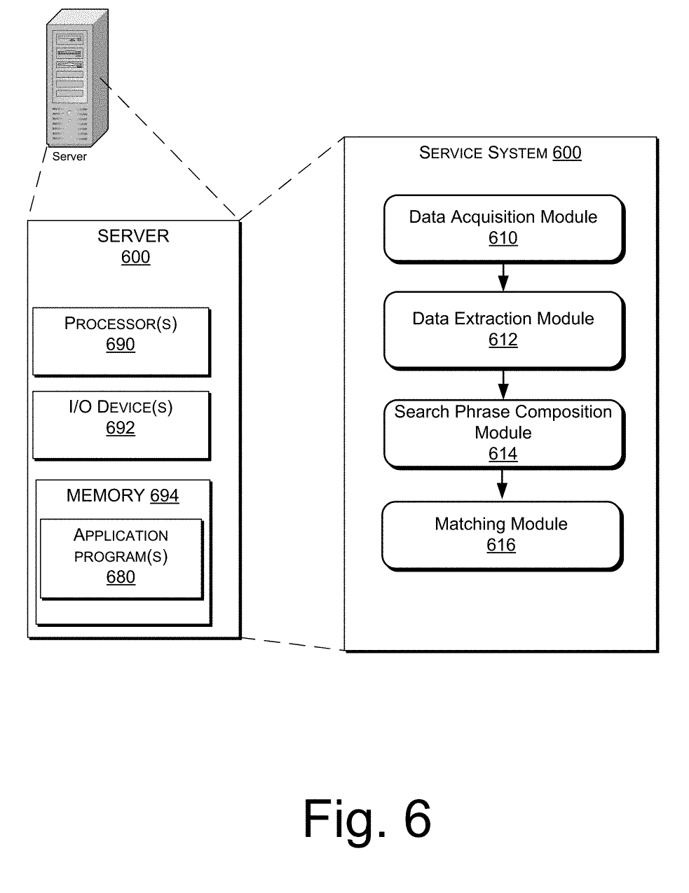

FIG. 6 is a block diagram representing a computer-based apparatus configured for searching product information in accordance with the present disclosure. The computer-based apparatus includes server 600 which has one or more processor(s) 690, I/O devices 692, and memory 694 which stores application program(s) 680. The server 600 is programmed to have the functional modules as described in the following.

Data acquisition module 610 is configured for acquiring a search behavioral data including an original search phrase entered in a search process, a product category selection selected in the search process, and a product attribute being searched.

Data extraction module 612 is configured for extracting the original search phrase, the product category selection, and the product attribute from the acquired search behavioral data.

Search phrase composition module 614 is configured for automatically composing a recommended search phrase by merging the original search phrase, the product category selection, and the product attribute.

Matching module 616 is configured for matching the recommended search phrase with a bid phrase stored in a product information database, and allowing at least some of the advertisements associated with the bid phrase matching the recommended search phrase to be displayed.

In some embodiments, matching module 616 is programmed to have a precise match submodule and a fuzzy match submodule. The precise match module is configured for matching the recommended search phrase with the bid phrase according to a precise matching rule. A typical precise matching rule may require an exact or almost exact match. If a precise match is found, the advertisements associated with the found matching bid price are displayed. But if the matching according to the precise matching rule fails, the fuzzy match submodule then matches the recommended search phrase with a bid phrase according to a fuzzy matching rule. If a related bid phrase is found based on the fuzzy matching rule, the fuzzy match submodule allows the advertisements associated with the related bid phrase to the displayed.

The functions performed by the functional modules of server 600 have been described with reference to FIG. 3 in the method of distributing advertisements, and are therefore not repeated.

The above embodiments of the apparatus are related to the embodiments of the method described herein, and detailed description of the embodiments of the method is also applicable to the embodiments of the apparatus and is therefore not repeated.

It is further noted that the method and the apparatus of the present disclosure are well-suited in a structured search setting, and because the vast majority of e-commerce websites and many other database-based commercial websites have structured searches, the present disclosure has a broad scope of practical applications.

The technique described in the present disclosure may be implemented in a general computing equipment or environment or a specialized computing equipment or environment, including but not limited to personal computers, server computers, hand-held devices or portable devices, tablet devices, multiprocessor systems, microprocessor-based systems, set-top boxes, programmable consumer devices, network PCs, microcomputers and large-scale mainframe computers, or any distributed environment including one or more of the above examples.

The modules in particular may be implemented using computer program modules based on machine executable commands and codes. Generally, a computer program module may perform particular tasks or implement particular abstract data types of routines, programs, objects, components, data structures, and so on. Techniques described in the present disclosure can also be practiced in distributed computing environments, such a distributed computing environment, to perform the tasks by remote processing devices connected through a communication network. In a distributed computing environment, program modules may be located in either local or remote computer storage media including memory devices.

It is appreciated that the potential benefits and advantages discussed herein are not to be construed as a limitation or restriction to the scope of the appended claims.

Methods and apparatus of information verification have been described in the present disclosure in detail above. Exemplary embodiments are employed to illustrate the concept and implementation of the present invention in this disclosure. The exemplary embodiments are only used for better understanding of the method and the core concepts of the present disclosure. Based on the concepts in this disclosure, one of ordinary skills in the art may modify the exemplary embodiments and application fields.

1. A method for composing a search phrase, the method comprising:
acquiring a search behavioral data including an original search phrase entered in a search process, a product category selection selected in the search process, and a product attribute being searched;
extracting the original search phrase, the product category selection, and the product attribute from the acquired search behavioral data; and
automatically composing a recommended search phrase by merging the original search phrase, the product category selection, and the product attribute, the recommended search phrase being comprehensive of elements of the original search phrase, the product category selection, and the product attribute.

2. The method as recited in claim 1, wherein merging the original search phrase, the product category selection, and the product attribute comprises:
tokenizing the original search phrase, the product category selection, and the product attribute to obtain a plurality of tokenized words.

3. The method as recited in claim 2, wherein merging the original search phrase, the product category selection, and the product attribute further comprises:
normalizing spellings of the plurality of tokenized words.

4. The method as recited in claim 1, wherein merging the original search phrase, the product category selection, and the product attribute comprises:
removing redundant information from the original search phrase, the product category selection and the product attribute, the redundant information including one or more of duplicate words, synonyms, and near-synonyms.

5. The method as recited in claim 4, wherein removing redundant information comprising:
computing a similarity between two tokenized words obtained by tokenizing the original search phrase, the product category selection and the product attribute;
determining if the two tokenized words are duplicating words, synonyms or near-synonyms by comparing the similarity with a preset threshold value; and
keeping one of the two tokenized words and discarding the other if the two tokenized words are duplicating words or synonyms, or keeping one of the two tokenized words and discarding the other according to a preset condition if the two tokenized words are near-synonyms.

6. The method as recited in claim 1, wherein merging the original search phrase, the product category selection, and the product attribute comprises:
finding a key content of the original search phrase, the product category selection and the product attribute.

7. The method as recited in claim 6, wherein finding the key content comprises:
tokenizing the original search phrase, the product category selection and the product attribute to obtain tokenized words;
for each tokenized word, acquiring an analysis parameter which includes a weight factor of the tokenized word and/or a click rate of the tokenized word, the weight factor depending on whether the tokenized word is from a search phrase, category information or a product attribute;
for each tokenized word, determining a level of significance according to the respective analysis parameter; and
determining the key content according to the levels of significance of the tokenized words.

8. The method as recited in claim 1, wherein merging the original search phrase, the product category selection and the product attribute comprises:
tokenizing the original search phrase, the product category selection and the product attribute to obtain one or more tokenized words;
for each tokenized word, acquiring an analysis parameter which includes a weight factor of the tokenized word and/or a click rate of the tokenized word, the weight factor depending on whether the tokenized word is from a search phrase, category information or a product attribute;
for each tokenized word, determining a level of significance according to the respective analysis parameter; and
reordering the tokenized words according to the levels of significance of the tokenized words.

9. A computer-based apparatus for composing a search phrase, the apparatus comprising:
a computer having a processor, computer-readable memory and storage medium, and I/O devices, the computer being programmed to have functional modules including:
a data acquisition module configured to acquire a search behavioral data including an original search phrase entered in a search process, a product category selection selected in the search process, and a product attribute being searched;
a data extraction module configured to extract the original search phrase, the product category selection, and the product attribute from the acquired search behavioral data; and
a search phrase composition module configured to automatically compose a recommended search phrase by merging the original search phrase, the product category selection, and the product attribute, the recommended search phrase being comprehensive of elements of the original search phrase, the product category selection, and the product attribute.

10. The computer-based apparatus as recited in claim 9, wherein the search phrase composition module includes:
a tokenization submodule configured to tokenize the original search phrase, the product category selection, and the product attribute to obtain a plurality of tokenized words; and
a normalization submodule configured to normalize spellings of the plurality of tokenized words.

11. The computer-based apparatus as recited in claim 9, wherein the search phrase composition module further includes a redundancy removal submodule, the redundancy removal submodule configured to remove redundant information from the original search phrase, the product category selection, and the product attribute, the redundant information including one or more of duplicate words, synonyms, and near-synonyms.

12. The computer-based apparatus as recited in claim 11, wherein the redundancy removal submodule is further configured to remove the redundant information by:
computing a similarity between two tokenized words obtained by tokenizing the original search phrase, the product category selection and the product attribute;
determining if the two tokenized words are duplicating words, synonyms or near-synonyms by comparing the similarity with a preset threshold value; and
keeping one of the two tokenized words and discarding the other if the two tokenized words are duplicating words or synonyms, or keeping one of the two tokenized words and discarding the other according to a preset condition if the two tokenized words are near-synonyms.

13. The computer-based apparatus as recited in claim 9, wherein the search phrase composition module further includes a key content analysis submodule, the key content analysis submodule configured to:
find a key content of the original search phrase, the product category selection and the product attribute;
tokenize the original search phrase, the product category selection and the product attribute to obtain tokenized words;
for each tokenized word, acquire an analysis parameter which includes a weight factor of the tokenized word and/or a click rate of the tokenized word, the weight factor depending on whether the tokenized word is from a search phrase, category information or a product attribute;
for each tokenized word, determine a level of significance according to the respective analysis parameter; and
determine the key content according to the levels of significance of the tokenized words.

14. The computer-based apparatus as recited in claim 13, wherein the search phrase composition module further includes a word reordering submodule, the work reordering submodule configured to:
reorder the tokenized words according to the levels of significance of the tokenized words.

15. A computer-readable storage medium storing computer-readable instructions executable by one or more processors, that when executed by the one or more processors, cause the one or more processors to perform operations comprising:
acquiring a search behavioral data including an original search phrase entered in a search process, a product category selection selected in the search process, and a product attribute being searched;
extracting the original search phrase, the product category selection, and the product attribute from the acquired search behavioral data; and
automatically composing a recommended search phrase by merging the original search phrase, the product category selection, and the product attribute, the recommended search phrase being comprehensive of elements of the original search phrase, the product category selection, and the product attribute.

16. The computer-readable storage medium as recited in claim 15, wherein merging the original search phrase, the product category selection, and the product attribute comprises:
tokenizing the original search phrase, the product category selection, and the product attribute to obtain a plurality of tokenized words; and
normalizing spellings of the plurality of tokenized words.

17. The computer-readable storage medium as recited in claim 15, wherein merging the original search phrase, the product category selection, and the product attribute comprises:
removing redundant information from the original search phrase, the product category selection and the product attribute, the redundant information including one or more of duplicate words, synonyms, and near-synonyms.

18. The computer-readable storage medium as recited in claim 17, wherein removing redundant information comprising:
computing a similarity between two tokenized words obtained by tokenizing the original search phrase, the product category selection and the product attribute;
determining if the two tokenized words are duplicating words, synonyms or near-synonyms by comparing the similarity with a preset threshold value; and
keeping one of the two tokenized words and discarding the other if the two tokenized words are duplicating words or synonyms, or keeping one of the two tokenized words and discarding the other according to a preset condition if the two tokenized words are near-synonyms.

19. The computer-readable storage medium as recited in claim 15, wherein merging the original search phrase, the product category selection, and the product attribute comprises:
finding a key content of the original search phrase, the product category selection and the product attribute.

20. The computer-readable storage medium as recited in claim 19, wherein finding the key content comprises:
tokenizing the original search phrase, the product category selection and the product attribute to obtain tokenized words;
for each tokenized word, acquiring an analysis parameter which includes a weight factor of the tokenized word and/or a click rate of the tokenized word, the weight factor depending on whether the tokenized word is from a search phrase, category information or a product attribute;
for each tokenized word, determining a level of significance according to the respective analysis parameter;
determining the key content according to the levels of significance of the tokenized words; and
reordering the tokenized words according to the levels of significance of the tokenized words.
